(19) United States
(12) Patent Application Publication
(10) Pub. No.: US 2024/0190115 A1
(43) Pub. Date: Jun. 13, 2024

(54) WIDE MICROPOROUS FILM

(71) Applicant: Celgard, LLC, Charlotte, NC (US)

(72) Inventors: David Anzini, Fort Mill, SC (US); Ronnie E. Smith, Huntersville, NC (US); Daniel R. Alexander, Matthews, NC (US)

(21) Appl. No.: 18/286,123

(22) PCT Filed: Apr. 12, 2022
(86) PCT No.: PCT/US2022/024353

§ 371 Date: Oct. 8, 2023

Related U.S. Application Data
(60) Provisional application No. 63/174,822, filed on Apr. 14, 2021.

(51) Int. Cl. B32B 27/32; B29D 7/01; B29D 99/00; B29K 105/04; B32B 27/08; C08J 5/18; H01M 50/403; H01M 50/417; H01M 50/42; H01M 50/426; H01M 50/44; H01M 50/457; H01M 50/489; H01M 50/491

(52) U.S. Cl. CPC B32B 27/32; B29D 7/01; B29D 99/0092; B32B 27/08; C08J 5/18; H01M 50/403; H01M 50/417; H01M 50/42; H01M 50/426; H01M 50/44; H01M 50/457; H01M 50/489; H01M 50/491; B29K 2023/04; B29K 2105/041; B32B 2250/242; B32B 2307/581; B32B 2307/724; B32B 2307/7376; B32B 2437/00; B32B 2571/00; B32B 2605/003; C08J 2323/06; C08J 2323/12

(57) ABSTRACT

In one aspect, a wide microporous film comprises one or more layers comprising a polyolefin, wherein the microporous film has a width of at least 50 inches and comprises one or more non-porous regions. In some embodiments, the microporous film is at least 55 inches or at least 60 inches. Moreover, in some embodiments, the non-porous region is located along a creased region of the microporous film.

### RELATED APPLICATIONS

This application is a 371 application to PCT Application No. PCT/US2022/024353, filed Apr. 12, 2022, which claims priority to U.S. Provisional Application No. 63/174,822, filed Apr. 14, 2021, which are incorporated herein by reference in their entireties.

### FIELD

In accordance with at least selected embodiments, the application, disclosure or invention relates to films, thin films, membranes, textiles, separator films, separator thin films, separator membranes, separators, battery separators, secondary lithium battery separators, multilayer membranes, multilayer separator membranes, multilayer separators, multilayer battery separators, multilayer secondary lithium battery separators, multilayer battery separators, batteries, capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or methods for testing, quantifying, characterizing, and/or analyzing such films, thin films, membranes, textiles, separator films, separator thin films, separator membranes, separators, battery separators, and the like. In accordance with at least certain selected embodiments, the disclosure or invention relates to porous polymer films, thin films, and/or membranes separators, textiles or battery separators including such films, thin films, membranes, and/or related methods. In accordance with at least particular embodiments, the disclosure or invention relates to microporous polyolefin films, thin films, or membranes, microlayer films, thin films, or membranes, multi-layer films, thin films, or membranes including one or more microlayer or nanolayer films, thin films, or membranes, textiles or battery separators including such films, thin films, or membranes, and/or related methods. In accordance with at least certain particular embodiments, the disclosure or invention relates to microporous stretched polymer membranes or separator membranes having one or more exterior layers and/or interior layers, microlayer films, thin films, or membranes, multi-layered microporous films, thin films, or membranes, or separator films, thin films, or membranes having exterior layers and interior layers, some of which layers or sublayers are created by co-extrusion and then laminated together to form the membranes or separator membranes. In some embodiments, certain layers, microlayers or nanolayers can comprise a homopolymer, a copolymer, block copolymer, and/or elastomer, blended with an inorganic nanoparticle filler. In select embodiments, at least certain layers, microlayers or nanolayers can comprise a different or distinct polymer, homopolymer, copolymer, block copolymer, and/or elastomer blended with an inorganic nanoparticle filler. The disclosure or invention also relates to methods for making such a films, thin films, or membrane, separator films, thin films, or membrane, or separator, and/or methods for using such a films, thin films, or membrane, separator films, thin films, or membrane or separator, for example as a textile or lithium battery separator. In accordance with at least selected embodiments, the application or invention is directed to multi-layered and/or microlayer porous or microporous films, thin films, or membranes, separator films, thin films, or membranes, separators, composites, textiles, electrochemical devices, and/or batteries, and/or methods of making and/or using such films, thin films, or membranes, separators, composites, textiles, devices and/or batteries. In accordance with at least particular selected embodiments, the application or invention is directed to separator membranes that are multi-layered, in which one or more layers of the multi-layered structure is produced in a multi-layer or microlayer co-extrusion die with multiple extruders. The membranes, separator membranes, or separators can demonstrate improved thermal stability, increased film toughness, improved electrolyte uptake, and/or improved pin-removal properties.

### BACKGROUND

Thin films and membranes, particularly polyolefin-based thin films and membranes, are used in a wide variety of applications. For example, polyolefin-based thin films and membranes are used as garment fabrics, textiles, and battery separators. However, when making thin films in larger widths, such as widths greater than 36 inches, thickness uniformity and Gurley uniformity are difficult to achieve.

Accordingly, there is a need for new and improved thin films and membranes over other prior thin films and membranes.

### SUMMARY

In one aspect, a wide microporous film comprises one or more layers comprising a polyolefin, wherein the microporous film has a width of at least 50 inches and comprises one or more non-porous regions. In some embodiments, the microporous film is at least 55 inches or at least 60 inches. Moreover, in some embodiments, the non-porous region is located along a creased region of the microporous film. The one or more non-porous regions, for example, can be located along a central crease in the microporous film. Additionally, the one or more non-porous regions can exhibit a re-solidified polymeric structure. As described herein, the microporous membrane can be melted and re-solidified to form the non-porous region.

Alternatively, the microporous membrane can be exposed to solvent and re-precipitated to form the one or more non-porous regions.

The polyolefin of the film can comprise a polypropylene, a polypropylene blend, a polypropylene copolymer, a polyethylene, a polyethylene blend, a polyethylene copolymer, a polyvinylidene fluoride (PVDF), a polyethylene oxide (PEO), a poly (methyl methacrylate) (PMMA), or any combination thereof in some embodiments. In some embodiments, the polyolefin is polyethylene, polypropylene, or a combination of both.

Wide microporous films can be a single layer film, a trilayer film, or a multilayer film. In some embodiments, one or all the layers comprise a dry process extruded thin film. In some cases, at least one layer comprises a dry process extruded thin film and at least one other layer comprises a woven or nonwoven film. The layers can be laminated together in some cases, or connected together using an adhesive.

In some embodiments, the wide microporous film comprises a thickness of about 1 microns to about 50 microns, about 5 microns to about 40 microns, about 5 microns to about 30 microns, about 5 microns to about 20 microns, or about 5 to 10 microns. In some cases, the wide microporous film has a thickness standard deviation of no more than 2.0 micron, no more than 1.0 microns, or no more than 0.5 microns.

In some instances, the wide microporous film has a Gurley value of 1 to 1,000 s/100 cc. In some embodiments, the wide microporous film has a Gurley standard deviation of no more than 15, no more than 10, no more than 5, or no more than 1.

The wide microporous film comprises a porosity of 20% to 80%, and can, in some instances, have a puncture strength of 300-1500 gf.

The microporous film can comprise a coating on one or more surfaces in some embodiments. In some instances, the coating is a ceramic comprising a polymeric binder and organic and/or inorganic particles.

The film can be a textile or garment fabric, in some embodiments.

In another aspect, methods of forming wide microporous films are described herein. In some embodiments, a method comprises providing a microporous film, and expanding width of the microporous film around a crease in the microporous film. The microporous film is then sealed along the crease to provide one or more non-porous regions. In some embodiments, the width of the microporous film is expanded to at least 40 inches, at least 50 inches, at least 60 inches, or any width value described herein. Sealing can comprise melting and re-solidifying the microporous membrane along the crease to provide the one or more non-porous regions.

Alternatively, solvent can be employed to destroy pore structure and/or redistribute polymeric material of the film to form non-porous region(s).

The non-porous region may be continuous along the crease and regions adjacent to the crease. The crease and adjacent regions, for example, can be contacted with a hot roller or other heat source having sufficient temperature to melt and/or redistribute polymer of the membrane, thereby destroying the pore structure. As described herein, the crease and adjacent regions can be contacted with solvent to form the non-porous region(s). In some embodiments, expanding the microporous film comprises unfolding the microporous film along the crease. Expanding the microporous film can create the crease, in some embodiments.

FIG. 1 illustrates a wide microporous membrane formed according to methods described herein. As illustrated in FIG. 1, width of the membrane is expanded via unfolding the membrane in the TD direction along a crease. The crease and adjacent regions pass under a heated roller to melt and/or redistribute polymer of the microporous membrane, thereby forming a continuous or discontinuous non-porous region.

As described further herein, the microporous film, in some embodiments, can be expanded by passing the film over a film expansion apparatus. For example, the microporous film in the folded state is passed over a shearing point to unfold the film along the crease. The unfolded film is subsequently sealed along the crease and wound or otherwise collected onto one or more rolls.

These and other embodiments are further described in the following detailed description.

### BRIEF DESCRIPTION OF THE DRAWINGS

FIG. 1 illustrates a wide microporous membrane formed according to methods described herein.

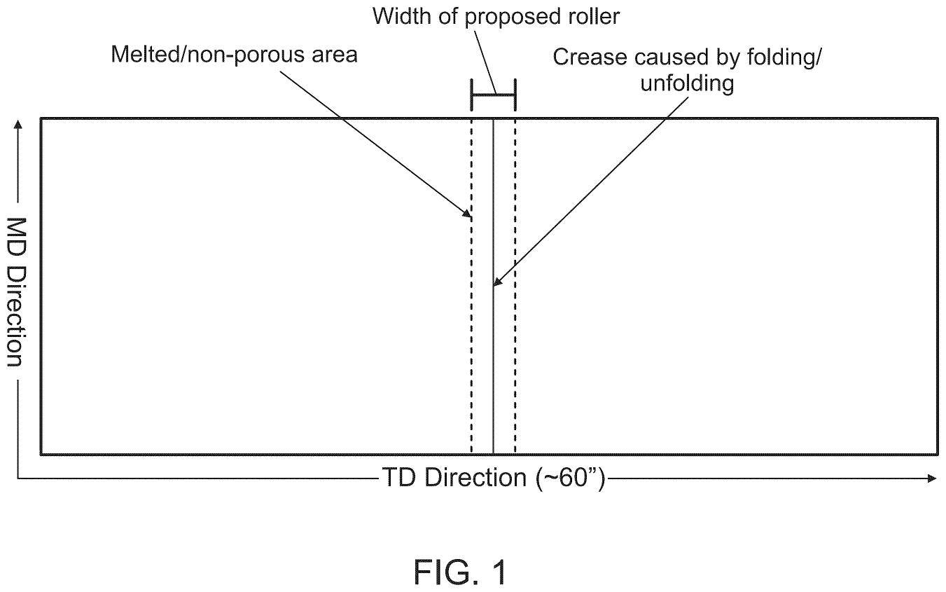

FIG. 2 is a schematic of a film expansion apparatus, according to some embodiments.

FIG. 3 illustrates operation of a film expansion apparatus, according to some embodiments.

FIG. 4 is a schematic drawing of an exemplary method for forming a film as described herein.

FIG. 5 is a schematic drawing of an exemplary method for forming a film as described herein.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

The terms “membrane,” “thin film,” “film” and “separator” are used interchangeably herein, and unless expressly specified, are to be interpreted as having the same meaning.

### I. Microporous Membrane

In one aspect, a wide microporous film comprises one or more layers comprising a polyolefin, wherein the microporous film has a width of at least 50 inches and comprises one or more non-porous regions. In some embodiments, the microporous film is at least 55 inches or at least 60 inches. Moreover, in some embodiments, the non-porous region is located along a central region of the microporous film. The one or more non-porous regions, for example, can be located along a crease in the microporous film. Additionally, the one or more non-porous regions can exhibit a re-solidified polymeric structure. As described herein, the microporous membrane can be melted and re-solidified to form the non-porous region.

A microporous membrane described herein can comprise one or more layers comprising one or more of a polyolefin, a fluorocarbon, a polyamide, a polyester, a polyacetal (or a polyoxymethylene), a polysulfide, a polyvinyl alcohol, a polyvinylidene, co-polymers thereof, or combinations thereof. In a preferred embodiment, a microporous membrane comprises a polyolefin. In some embodiments, the polyolefin comprising a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA) or any combination thereof. In some cases, the polyolefin is a polyethylene a polypropylene, or a combination of both.

In some embodiments, a polyolefin can be an ultra-low molecular weight, a low-molecular weight, a medium molecular weight, a high molecular weight, or an ultra-high molecular weight polyolefin, such as a medium or a high weight polyethylene (PE) or polypropylene (PP). For example, an ultra-high molecular weight polyolefin can have a molecular weight of 450,000 (450 k) or above, e.g. 500 k or above, 650 k or above, 700 k or above, 800 k or above, 1 million or above, 2 million or above, 3 million or above, 4 million or above, 5 million or above, 6 million or above, and so on. A high-molecular weight polyolefin can have a molecular weight in the range of 250 k to 450 k, such as 250 k to 400 k, 250 k to 350 k, or 250 k to 300 k. A medium molecular weight polyolefin can have a molecular weight from 150 to 250 k, such as 100 k, 125 k, 130K, 140 k, 150 k to 225 k, 150 k to 200 k, 150 k to 200 k, and so on. A low molecular weight polyolefin can have a molecular weight in the range of 100 k to 150 k, such as 100 k to 125 k. An ultra-low molecular weight polyolefin can have a molecular weight less than 100 k. The foregoing values are weight average molecular weights. In some embodiments, a higher molecular weight polyolefin can be used to increase strength or other properties of the porous membrane or batteries comprising the same as described herein. In some embodiments, a lower molecular weight polymer, such as a medium, low, or ultra-low molecular weight polymer can be beneficial. For example, without wishing to be bound by any particular theory, it is believed that the crystallization behavior of lower molecular weight polyolefins can result in a porous membrane having smaller pores resulting from at least an MD stretching process that forms the pores.

Fluorocarbons can comprise polytetrafluoroethylene (PTFE), polychlorotrifluoroethylene (PCTFE), fluorinated ethylene propylene (FEP), ethylenechlortrifluoroethylene (ECTFE), ethylene tetrafluoroethylene (ETFE), polyvinylidene fluoride (PVDF), polyvinylfluoride (PVF), prefluoroalkoxy (PFA) resin, co-polymers thereof, or combinations thereof. Polyamides can comprise, but are not limited to: polyamide 6, polyamide 6/6, Nylon 10/10, polyphthalamide (PPA), co-polymers thereof, or combinations thereof. Polyesters can comprise polyester terephthalate (PET), polybutylene terephthalate (PBT), poly-1-4-cyclohexylenedimethylene terephthalate (PCT), polyethylene naphthalate (PEN), or liquid crystal polymers (LCP). Polysulfides can comprise, but are not limited to, polyphenylsulfide, polyethylene sulfide, co-polymers thereof, or combinations thereof. Polyvinyl alcohols can comprise, but are not limited to, ethylenevinyl alcohol, co-polymers thereof, or combinations thereof. Polyvinylidenes include, but are not limited to: fluorinated polyvinylidenes (such as polyvinylidene chloride, polyvinylidene fluoride), copolymers thereof, and blends thereof

A microporous membrane can in some instances comprise a semi-crystalline polymer, such as polymers having a crystallinity in the range of 20 to 80%.

In some embodiments, a microporous membrane described herein can comprise a single layer, a bi-layer, a tri-layer, or multilayers. For example, a tri-layer or multilayer membrane can comprise two outer layers and one or more inner layers. In some instances, a microporous membrane can comprise 1, 2, 3, 4, 5, or more inner layers. As described in more detail below, each of the layers can be coextruded and/or laminated together. Further, the term “multilayer” can include 2, 3, 4, 5, 6, 7, 8, 9, 10, or more layers.

A microporous membrane described herein can be made by a dry stretch process (such as a Celgard® dry stretch process described herein) in which one or more polymers are extruded to form the membrane. Each of the outer and inner layers can be mono-extruded, where the layer is extruded by itself, without any sublayers (plies), or each layer can comprise a plurality of co-extruded sublayers. For example, each layer can comprise a plurality of sublayers, such as a co-extruded bi-sublayer, tri-sublayer, or multi-sublayer membrane, each of which can collectively considered to be a “layer”. The number of sublayers in coextruded bi-layer is two, the number of layers in a co-extruded tri-layer is three, and the number of layers in a co-extruded multi-layer membrane will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer membrane can be formed using the same material in each of the two, three, or four or more sublayers, and these sublayers will still be considered to be separate sublayers even though each sublayer is made of the same material.

In some embodiments, a tri-layer or multilayer microporous membrane described herein can comprise two outer layers (such as a first outer layer and a second outer layer) and a single or plurality of inner layers. The plurality of inner layers can be mono-extruded or co-extruded layers. A lamination barrier can be formed between each of the inner layers and/or between each of the outer layers and one of the inner layers. A lamination barrier can be formed when two surfaces, such as two surfaces of different membranes or layers are laminated together using heat, pressure, or heat and pressure.

In some embodiments, a microporous membrane described herein can have the following non-limiting constructions: PP, PE, PP/PP, PP/PE, PE/PP, PE/PE, PP/PP/PP, PP/PP/PE, PP/PE/PE. PP/PE/PP, PE/PP/PE, PE/PE/PP, PP/PP/PP/PP, PP/PE/PE/PP, PE/PP/PP/PE, PP/PE/PP/PP, PE/PE/PP/PP, PE/PP/PE/PP, PP/PE/PE/PE/PP, PE/PP/PP/PP/PE, PP/PP/PE/PP/PP, PE/PE/PP/PP/PE/PE, PP/PE/PP/PE/PP, PP/PP/PE/PE/PP/PP, PE/PE/PP/PP/PE/PE, PE/PP/PE/PP/PE/PP, PP/PE/PP/PE/PP/PE, PP/PP/PP/PE/PP/PP/PP, PE/PE/PE/PP/PE/PE/PE, PP/PE/PP/PE/PP/PE/PP, PE/PP/PE/PP/PE/PP/PE, PE/PP/PE/PP/PE/PP/PE/PP, PP/PE/PP/PE/PP/PE/PP/PE, PP/PP/PE/PE/PP/PP/PE/PE, PP/PE/PE/PE/PE/PE/PE/PP, PE/PP/PP/PP/PP/PP/PP/PE, PP/PP/PE/PE/PEPE/PP/PP, PP/PP/PP/PP/PE/PE/PE/PE, PP/PP/PP/PP/PE/PP/PP/PP/PP, PE/PE/PE/PE/PP/PE/PE/PE/PE, PP/PE/PP/PE/PP/PE/PP/PE/PP, PE/PP/PE/PP/PE/PP/PE/PP/PE, PE/PE/PE/PE/PE/PP/PP/PP/PP, PP/PP/PP/PP/PP/PE/PE/PE/PE, PP/PP/PP/PP/PP/PE/PE/PE/PE/PE, PE/PE/PE/PE/PE/PP/PP/PP/PP/PP, PP/PE/PP/PE/PP/PE/PP/PE/PP/PE, PE/PP/PE/PP/PE/PP/PE/PP/PE/PP, PE/PP/PP/PP/PP/PP/PP/PP/PP/PP/PE, PP/PE/PE/PE/PE/PE/PE/PE/PE/PE/PP, PP/PP/PE/PE/PP/PP/PE/PE/PP/PP, PE/PE/PP/PP/PP/PP/PP/PP/PP/PE/PE, PP/PP/PP/PE/PE/PP/PP/PP/PP/PE, or PE/PE/PE/PP/PP/PE/PE/PE/PP/PP. For purposes of reference herein PE denotes a single layer within the multilayer membrane that comprises PE. Similarly, PP denotes a single layer within the multilayer membrane that comprises PP. Thus, a PP/PE designation would represent a bi-layer membrane having a polypropylene (PP) layer and a polyethylene (PE) layer.

Individual layers in a microporous membrane can comprise a plurality of sublayers, which can be formed by co-extrusion or combining the individual sublayers to form the individual layer of the multilayer membrane. Using a multilayer membrane having a structure of PP/PE/PP, each individual PP or PE layer can comprise two or more co-extruded sublayers. For example, when each individual PP or PE layer comprises three sublayers, each individual PP layer can be expressed as PP=(PP1, PP2, PP3) and each individual PE layer can be expressed as PE=(PE1, PE2, PE3). Thus, the structure of PP/PE/PP can be expressed as (PP1,PP2,PP3)/(PE1,PE2,PE3)/(PP1,PP2,PP3). The composition of each of the PP1, PP2, and PP3 sublayers can be the same, or each sublayer can have a different polypropylene composition than one or both of the other polypropylene sublayers. Similarly, composition of each of the PE1, PE2, and PE3 sublayers can be the same, or each sublayer can have a different polyethylene composition than one or both of the other polyethylene sublayers. This principle applies to other multilayer membranes having more or less layers that the above-described exemplary tri-layer membrane.

In some instances, at least one layer in the microporous membrane comprises a dry process extruded thin film and at least one other layer comprises a woven or nonwoven film. For example, one or more extruded thin films can be combined, laminated, adhered, or otherwise connected to a woven or nonwoven film.

Microporous membranes described herein can have any thickness not inconsistent with the objectives of this disclosure. In some embodiments, the microporous membrane has an overall thickness of 1 micron to 60 microns, 1 micron to 55 microns, 1 micron to 50 microns, 1 micron to 45 microns, 1 micron to 40 microns, 1 micron to 35 microns, 1 micron to 30 microns, 1 micron to 25 microns, 1 micron to 20 microns, 1 micron to 15 microns, 1 micron to 10 microns, 5 microns to 50 microns, 5 microns to 40 microns, 5 microns to 30 microns, 5 microns to 25 microns, 5 microns to 20 microns, 5 microns to 10 microns, 10 microns to 40 microns, 10 microns to 35 microns, 10 microns to 30 microns, or 10 microns to 20 microns. In a preferred embodiment, the microporous membrane has a thickness of about 1 microns to about 50 microns, about 5 microns to about 40 microns, about 5 microns to about 30 microns, about 5 microns to about 20 microns, or about 5 to 10 microns.

Microporous membranes described herein are a wide microporous membrane. In some embodiments, the wide microporous membrane has a width of a least 40 inches, at least 45 inches, at least 50 inches, at least 55 inches, at least 60 inches, at least 65 inches, at least 70 inches, 36-150 inches, 40 to 150 inches, 45 to 140 inches, 50 to 140 inches, 55 to 130 inches, 60 to 130 inches, 65 to 120 inches, 70 to 120 inches, 75 to 110 inches, 80 to 110 inches, 85 to 100 inches, or 90 to 100 inches.

The microporous membrane has a relatively uniform thickness across the width. In some instances, the membrane has a thickness standard deviation of no more than 2.0 micron, no more than 1.0 microns, or no more than 0.5 microns, 0.01 microns to 2 microns, 0.1 to 2 microns, 0.3 microns to 2 microns, 0.5 microns to 2 microns, 0.7 microns to 2 microns, 1 microns to 2 microns, 1.5 microns to 2 microns, 0.01 microns to 1.7 microns, 0.01 microns to 1.5 microns, 0.01 microns to 1.3 microns, 0.01 microns to 1 micron, 0.01 microns to 0.7 microns, 0.01 microns to 0.5 microns, 0.01 microns to 0.3 microns, or 0.01 microns to 0.1 microns.

In some embodiments, each layer in bi-layer, tri-layer, or multi-layer microporous membrane can have a thickness equal to a thickness of the other layers, or have a thickness that is less than or greater than a thickness of the other layers. For example, when a microporous membrane is a tri-layer membrane comprising a structure of PP/PE/PP (polypropylene/polyethylene/polypropylene) or PE/PP/PE (polyethylene/polypropylene/polyethylene), the polypropylene layers can have a thickness equal to a thickness of the polyethylene layer(s), have a thickness less than a thickness of the polyethylene layer(s), or have a thickness greater than a thickness of the polyethylene layer(s).

In some embodiments, a microporous membrane described herein can be a tri-layer laminated PP/PE/PP (polypropylene/polyethylene/polypropylene) or a PE/PP/PE (polyethylene/polypropylene/polyethylene) microporous membrane. In some instances, a structure ratio of the layers of the microporous membrane can comprise 45/10/45%, 40/20/40%, 39/22/39%, 38/24/38%, 37/26/37%, 36/28/36%, 35/30/35%, 34.5/31/34.5%, 34/32/34%, 33.5/33/33.5%, 33/34/33%, 32.5/35/32.5%, 32/36/32%, 31.5/37/31.5%, 31/38/31%, 30.5/39/30.5%, 30/40/30%, 29.5/41/29.5%, 29/42/29%, 28.5/43/28.5%, 28/44/28%, 27.5/45/27.5%, or 27/46/27%.

A microporous membrane described herein can additionally comprise fillers, elastomers, wetting agents, lubricants, flame retardants, nucleating agents, and other additional elements not inconsistent with the objectives of this disclosure. For example, the membrane can comprise fillers such as calcium carbonate, zinc oxide, diatomaceous earth, talc, kaolin, synthetic silica, mica, clay, boron nitride, silicon dioxide, titanium dioxide, barium sulfate, aluminum hydroxide, magnesium hydroxide and the like, or combinations thereof. Elastomers can comprise ethylene-propylene (EPR), ethylene-propylene-diene (EPDM), styrene-butadiene (SBR), styrene isoprene (SIR), ethylidene norbornene (ENB), polyisoprene, epoxy, and polyurethane or combinations thereof. Wetting agents can comprise ethoxylated alcohols, primary polymeric carboxylic acids, glycols (such as polypropylene glycol and polyethylene glycols), functionalized polyolefins, and the like. Lubricants can comprise a silicone, a fluoropolymer, oleamide, stearamide, erucamide, calcium stearate, or other metallic stearates. Flame retardants can comprise brominated flame retardants, ammonium phosphate, ammonium hydroxide, alumina trihydrate, and phosphate ester. Nucleating agents can comprise any nucleating agents not inconsistent with the objectives of this disclosure, such as beta-nucleating agents for polypropylene, which is disclosed in U.S. Pat. No. 6,602,593.

A microporous membrane described in some of the embodiments herein, can in some instances, be made by a dry-stretch process. A microporous membrane is understood to be a thin, pliable, polymeric sheet, foil, or membrane having a plurality of pores extending therethrough. In some cases, the porous membrane is made by the dry-stretch process (also known as the CELGARD® process), which refers to a process where pore formation results from stretching a nonporous, semicrystalline, extruded polymer precursor in the machine direction (MD), transverse direction (TD), or in both an MD and TD. See, for example, Kesting, Robert E., Synthetic Polymeric Membranes, A Structural Perspective, Second Edition, John Wiley & Sons, New York, N.Y., (1985), pages 290-297, incorporated herein by reference. Such a dry-stretch process is different from the wet process and the particle stretch process. Generally, in the wet process, also known as a phase inversion process, an extraction process, or a TIPS process, a polymeric raw material is mixed with a processing oil (sometimes referred to as a plasticizer), this mixture is extruded, and pores are formed when the processing oil is removed. While these wet process membranes may be stretched before or after the removal of the oil, the principle pore formation mechanism is the use of the processing oil. A porous membrane described herein can in some instances be any polyolefin microporous separator membrane available from Celgard, LLC of Charlotte, N.C.

A porous membrane can be a macroporous membrane, a mesoporous membrane, a microporous membrane, or a nanoporous membrane. The porosity of the membrane can be any porosity not inconsistent with the goals of this disclosure. For example, any porosity that could form an acceptable battery separator is acceptable. In some embodiments, the porosity of the porous substrate is from 20 to 90%, from 20 to 80%, from 40 to 80%, from 20 to 70%, from 40 to 70%, from 40-60%, more than 20%, more than 30%, or more than 40%. Porosity is measured using ASTM D-2873 and is defined as the percentage of void space, e.g., pores, in an area of the porous substrate, measured in the Machine Direction (MD) and the Transverse Direction (TD) of the substrate. In some embodiments, the pores are round with a sphericity factor of 0.25 to 8.0, or are oblong, or are oval-shaped.

A microporous membrane can have any Gurley not inconsistent with the objectives of this disclosure, such as a Gurley that is acceptable for use as a garment fabric, textile, or battery separator. Gurley is the Japanese Industrial Standard (JIS Gurley) and can be measured using a permeability tester, such as an OHKEN permeability tester. JIS Gurley is defined as the time in seconds required for 100 cc of air to pass through one square inch of membrane at a constant pressure of 4.9 inches of water. In some embodiments, the porous film or membrane described herein has a JIS Gurley (s/100 cc) of 1 or more, 10 or more, 50 or more, 100 or more, 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, 350 or more, 1 to 1000, 50 to 900, 100 to 800, 200 to 700, 200 to 600, 200 to 500, 200 to 400, 200 to 300, or 300 to 600.

Microporous membranes described herein can have a relatively uniform Gurley standard deviation across the width thereof. For instance, in some embodiments, a membrane has a Gurley standard deviation of no more than 15, no more than 10, no more than 5, no more than 1, 0.5 to 15, 1 to 15, 2 to 15, 3 to 15, 4 to 15, 5 to 15, 6 to 15, 7 to 15, 8 to 15, 8 to 15, 10 to 15, 11 to 15, 12 to 15, 13 to 15, 0.5 to 14, 0.5 to 13, 0.5 to 12, 0.5 to 11, 0.5 to 10, 0.5 to 9, 0.5 to 8, 0.5 to 7, 0.5 to 6, 0.5 to 5, 0.5 to 4, 0.5 to 3, 0.5 to 2, or 0.5 to 1.

A microporous membrane described herein can have a puncture strength, uncoated, of 200 gf or more, 210 gf or more, 220 gf or more, 230 gf or more, 240 gf or more, 250 gf or more, 260 gf or more, 270 gf or more, 280 gf or more, 290 gf or more, 300 gf or more, 310 gf or more, 320 gf or more, 330 gf or more, 340 gf or more, 350 gf or more, 400 gf or more, 450 gf or more, 500 gf or more, 550 gf or more, 600 gf or more, 650 gf or more, 700 gf or more, 750 gf or more, 800 gf or more, 850 gf or more, 900 gf or more, 1000 gf or more, 1100 gf or more, 1200 gf or more, 1300 gf or more, 1400 gf or more, 1500 gf or more, 500-1500 gf, 600-1500 gf, 700-1500 gf, 800-1500 gf, 900-1500 gf, 1000-1500 gf, 1100-1500 gf, 1200-1500 gf, 1300-1500 gf, 500-1400 gf, 500-1400 gf, 500-1300 gf, 500-1200 gf, 500-1100 gf, 500-1000 gf, 500-900 gf, 500-800 gf, or 500-700 gf.

In some embodiments, a microporous membrane described herein can comprise one or more additives in at least one layer of the porous membrane. In some embodiments, at least one layer of a porous membrane comprises more than one, such as two, three, four, five, or more, additives. Additives can be present in one or both of the outermost layers of the porous membrane, in one or more inner layers, in all of the inner layers, or in all of the inner and both of the outermost layers. In some embodiments, additives can be present in one or more outermost layers and in one or more innermost layers. In such embodiments, over time, an additive can be released from the outermost layer or layers and the additive supply of the outermost layer or layers can be replenished by migration of the additive in the inner layers to the outermost layers. In some embodiments, each layer of a microporous membrane can comprise a different additive or combination of additives than an adjacent layer of the microporous membrane.

In some embodiments, an additive comprises a functionalized polymer. As understood by one of ordinary skill in the art, a functionalized polymer is a polymer with functional groups coming off of the polymeric backbone. Exemplary functional groups include: In some embodiments, the functionalized polymer is a maleic anhydride functionalized polymer. In some embodiments the maleic anhydride modified polymer is a maleic anhydride homo-polymer polypropylene, copolymer polypropylene, high density polypropylene, low-density polypropylene, ultra-high density polypropylene, ultra-low density polypropylene, homo-polymer polyethylene, copolymer polyethylene, high density polyethylene, low-density polyethylene, ultra-high density polyethylene, ultra-low density polyethylene,

In some embodiments, an additive comprises an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer.

In some embodiments, an additive comprises cellulose nanofiber.

In some embodiments, an additive comprises inorganic particles having a narrow size distribution. For example, the difference between D10 and D90 in a distribution is less than 100 nanometers, less than 90 nanometers, less than 80 nanometers, less than 70 nanometers, less than 60 nanometers, less than 50 nanometers, less than 40 nanometers, less than 30 nanometers, less than 20 nanometers, or less than 10 nanometers. In some embodiments, the inorganic particles are selected from at least one of SiO₂, TiO₂, or combinations thereof.

In some embodiments, an additive comprises a lubricating agent. A lubricating agent or lubricant described herein can be any lubricating agent not inconsistent with the objectives of this disclosure. As understood by one of ordinary skill in the art, a lubricant is a compound that acts to reduce the frictional force between a variety of different surfaces, including the following: polymer:polymer; polymer:metal; polymer; organic material; and polymer:inorganic material. Specific examples of lubricating agents or lubricants as described herein are compounds comprising siloxy functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH3 or C2H5. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

A fatty acid salt described herein can be any fatty acid salt not inconsistent with the objectives of this disclosure. In some instances, a fatty acid salt can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca.

A fatty acid salt can be lithium stearate, sodium stearate, lithium oleate, sodium oleate, sodium palmitate, lithium palmitate, potassium stearate, or potassium oleate.

A lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point.

In some embodiments, an additive can comprise one or more nucleating agents. As understood by one of ordinary skill in the art, nucleating agents are, in some embodiments, materials, inorganic materials, that assist in, increase, or enhance crystallization of polymers, including semi-crystalline polymers.

In some embodiments, an additive can comprise a cavitation promoter. Cavitation promoters, as understood by those skilled in the art, are materials that form, assist in formation of, increase formation of, or enhance the formation of bubbles or voids in the polymer.

In some embodiments, an additive can comprise a fluoropolymer, such as the fluoropolymers discussed in detail herein.

In some embodiments, an additive can comprise a cross-linker.

In some embodiments, an additive can comprise an x-ray detectable material. An x-ray detectable material can be any x-ray detectable material not inconsistent with the objectives of this disclosure, such as, for example, those disclosed in U.S. Pat. No. 7,662,510, which is incorporated by reference herein in its entirety. Suitable amounts of the x-ray detectable material or element are also disclosed in the '510 patent, but in some embodiments, up to 50 weight %, up to 40 weight %, up to 30 weight %, up to 20 weight %, up to 10 weight %, up to 5 weight %, or up to 1 weight % based on the total weight of the porous film or membrane can be used. In an embodiment, the additive is barium sulfate.

In some embodiments, an additive can comprise a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of a battery separator.

In some embodiments, an additive can comprise a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, an additive can comprise high temperature melt index (HTMI) polymer. The HTMI polymer can be any HTMI polymer not inconsistent with the objectives of this disclosure. In some instances, the HTMI polymer can be at least one selected from the group consisting of PMP, PMMA, PET, PVDF, Aramid, syndiotactic polystyrene, and combinations thereof.

In some embodiments, an additive can comprise an electrolyte. Electrolytes as described herein can be any electrolyte not inconsistent with the objectives of this disclosure. The electrolyte can be any additive typically added by battery makers, particularly lithium battery makers to improve battery performance. Electrolytes must also be capable of being combined, such as miscible, with the polymers used for the polymeric porous membrane or compatible with the coating slurry. Miscibility of the additives can also be assisted or improved by coating or partially coating the additives. For example, exemplary electrolytes are disclosed in A Review of Electrolyte Additives for Lithium-Ion Batteries, J. of Power Sources, vol. 162, issue 2, 2006 pp. 1379-1394, which is incorporated by reference herein in its entirety. In some embodiments, the electrolyte is at least one selected from the group consisting of a solid electrolyte interphase (SEI) improving agent, a cathode protection agent, a flame retardant additive, LiPF6 salt stabilizer, an overcharge protector, an aluminum corrosion inhibitor, a lithium deposition agent or improver, or a solvation enhancer, an aluminum corrosion inhibitor, a wetting agent, and a viscosity improver. In some embodiments, the electrolyte can have more than one property, such as it can be a wetting agent and a viscosity improver.

Exemplary SEI improving agents include VEC (vinyl ethylene carbonate), VC (vinylene carbonate), FEC (fluoroethylene carbonate), LiBOB (Lithium bis(oxalato) borate). Exemplary cathode protection agents include N,N′-dicyclohexylcarbodiimide, N,N-diethylamino trimethylsilane, LiBOB. Exemplary flame-retardant additives include TTFP (tris(2,2,2-trifluoroethyl) phosphate), fluorinated propylene carbonates, MFE (methyl nonafluorobuyl ether). Exemplary LiPF6 salt stabilizers include LiF,TTFP (tris(2,2,2-trifluoroethyl) phosphite), 1-methyl-2-pyrrolidinone, fluorinated carbamate, hexamethyl-phosphoramide. Exemplary overcharge protectors include xylene, cyclohexylbenzene, biphenyl, 2, 2-diphenylpropane, phenyl-tert-butyl carbonate. Exemplary Li deposition improvers include AlI₃, SnI₂, cetyltrimethylammonium chlorides, perfluoropolyethers, tetraalkylammonium chlorides with a long alkyl chain. Exemplary ionic salvation enhancer include 12-crown-4, TPFPB (tris(pentafluorophenyl)). Exemplary Al corrosion inhibitors include LiBOB, LiODFB, such as borate salts. Exemplary wetting agents and viscosity dilutersinclude cyclohexane and P₂O₅.

In some embodiments, the electrolyte additive is air stable or resistant to oxidation. A battery separator comprising the electrolyte additive disclosed herein can have a shelf life of weeks to months, e.g. one week to 11 months.

In some embodiments, an additive can comprise an energy dissipative non-miscible additive. Non-miscible means that the additive is not miscible with the polymer used to form the layer of the porous film or membrane that contains the additive.

As previously discussed, a membrane described herein can be MD stretched or TD stretched to make the membrane porous. In some instances, the microporous membrane is produced by sequentially performing a TD stretch of an MD stretched microporous membrane, or by sequentially performing an MD stretch of a TD stretched microporous membrane. In addition to a sequential MD-TD stretching, the microporous membrane can also simultaneously undergo a biaxial MD-TD stretching. Moreover, the simultaneous or sequential MD-TD stretched porous membrane can be followed by a subsequent calendaring step to reduce the membrane's thickness, reduce roughness, reduce percent porosity, increase TD tensile strength, increase uniformity, and/or reduce TD splittiness.

In some embodiments, a microporous membrane can comprise pores having an average pore size of 0.01 micron to 1 micron, 0.02 micron to 1 micron, 0.03 micron to 1 micron, 0.04 micron to 1 micron, 0.05 micron to 1 micron, 0.06 micron to 1 micron, 0.07 micron to 1 micron, 0.08 micron to 1 micron, 0.09 micron to 1 micron, 0.1 micron to 1 micron, 0.2 micron to 1 micron, 0.3 micron to 1 micron, 0.4 micron to 1 micron, 0.5 micron to 1 micron, 0.6 micron to 1 micron, 0.7 micron to 1 micron, 0.8 micron to 1 micron, 0.9 micron to 1 micron, 0.01 micron to 0.9 micron, 0.01 micron to 0.8 micron, 0.01 micron to 0.7 micron, 0.01 micron to 0.6 micron, 0.01 micron to 0.5 micron, 0.01 micron to 0.4 micron, 0.01 micron to 0.3 micron, 0.01 micron to 0.2 micron, 0.01 micron to 0.1 micron, 0.01 micron to 0.09 micron, 0.01 micron to 0.08 micron, 0.01 micron to 0.07 micron, 0.01 micron to 0.06 micron, 0.01 micron to 0.05 micron, 0.01 micron to 0.04 micron, 0.01 micron to 0.03 micron, 1 micron, 0.9 micron, 0.8 micron, 0.7 micron, 0.6 micron, 0.5 micron, 0.4 micron, 0.3 micron, 0.2 micron, 0.1 micron, 0.09 micron, 0.08 micron, 0.07 micron, 0.06 micron, 0.05 micron, 0.04 micron, 0.03 micron, 0.02 micron, or 0.01 micron.

In an embodiment, a porous membrane can be manufactured using an exemplary process that includes stretching and a subsequent calendaring step such as a machine direction stretching followed by transverse direction stretching (with or without machine direction relax) and a subsequent calendaring step as a method of reducing the thickness of such a stretched membrane, for example, a multilayer porous membrane, in a controlled manner, to reduce the percent porosity of such a stretched membrane, for example, a multilayer porous membrane, in a controlled manner, and/or to improve the strength, properties, and/or performance of such a stretched membrane, for example, a multilayer porous membrane, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched membrane, for example, a multilayer porous membrane, in a controlled manner, and/or to produce a unique structure, pore structure, material, membrane, base membrane, and/or separator. In some instances, the low growth or shrinkage properties of conventional porous membranes can be increased by increasing the % of MD and/or TD stretch over a conventional stretch %, where the MD and/or TD stretch is either a cold stretch or a hot stretch process.

In some instances, the TD tensile strength of the multilayer membrane can be further improved by the addition of a calendaring step following TD stretching. The calendaring process typically involves heat and pressure that can reduce the thickness of a porous membrane. The calendaring process step can recover the loss of MD and TD tensile strength caused by TD stretching. Furthermore, the increase observed in MD and TD tensile strength with calendaring can create a more balanced ratio of MD and TD tensile strength, which can be beneficial to the overall mechanical performance of the multilayer membrane.

The calendaring process can use uniform or non-uniform heat, pressure and/or speed to selectively densify a heat sensitive material, to provide a uniform or non-uniform calendar condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendaring temperature of 50° C. to 70° C. and a line speed of 40 to 80 ft/min can be used, with a calendaring pressure of 50 to 200 psi. The higher pressure can in some instances provide a thinner separator, and the lower pressure provide a thicker separator.

In some embodiments, one or more coating layers can be applied to one or two sides of the multilayer membrane. In some embodiments, one or more of the coatings can be a ceramic coating comprising a polymeric binder and organic and/or inorganic particles. In some embodiments, only a ceramic coating is applied to one or both sides of the microporous membrane. In other embodiments, a different coating can be applied to the microporous membrane before or after the application of the ceramic coating. The different additional coating can be applied to one or both sides of the membrane or film also. In some embodiments, the different polymeric coating layer can comprise at least one of polyvinylidene difluoride (PVdF) or polycarbonate (PC).

In some embodiments, the thickness of the coating layer is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein can be coated onto a porous substrate by at least one of the following coating methods: extrusion coating, roll coating, gravure coating, printing, knife coating, air-knife coating, spray coating, dip coating, or curtain coating. The coating process can be conducted at room temperature or at elevated temperatures.

The coating layer can be any one of nonporous, nanoporous, microporous, mesoporous or macroporous. The coating layer can have a JIS Gurley of 700 or less, sometimes 600 or less, 500 or less, 400 or less, 300 or less, 200 or less, or 100 or less.

One or more layers, treatments, materials, or coatings (CT) and/or nets, meshes, mats, wovens, or non-wovens (NW) can be added on one or both sides, or within the multilayer film or membrane (M) described herein, which can include but not limited to CT/M, CT/M/CT, NW/M, NW/M/NW, CT/M/NW, CT/NW/M/NW/CT, CT/M/NW/CT, etc.

### II. Methods of Making Microporous Membranes

In another aspect, methods of forming wide microporous films are described herein. In some embodiments, a method comprises providing a microporous film, and expanding width of the microporous film around a crease in the microporous film. The microporous film is then sealed along the crease to provide one or more non-porous regions. In some embodiments, the width of the microporous film is expanded to at least 50 inches, at least 60 inches, or any width value described herein. Sealing can comprise melting and re-solidifying the microporous membrane along the crease to provide the one or more non-porous regions. The non-porous region may be continuous along the crease and regions adjacent to the crease. The one or more non-porous regions, for example, can be contacted with a hot roller or other heat source having sufficient temperature to melt and/or redistribute polymer of the membrane, thereby destroying the pore structure. In some embodiments, expanding the microporous film comprises unfolding the microporous film along the crease.

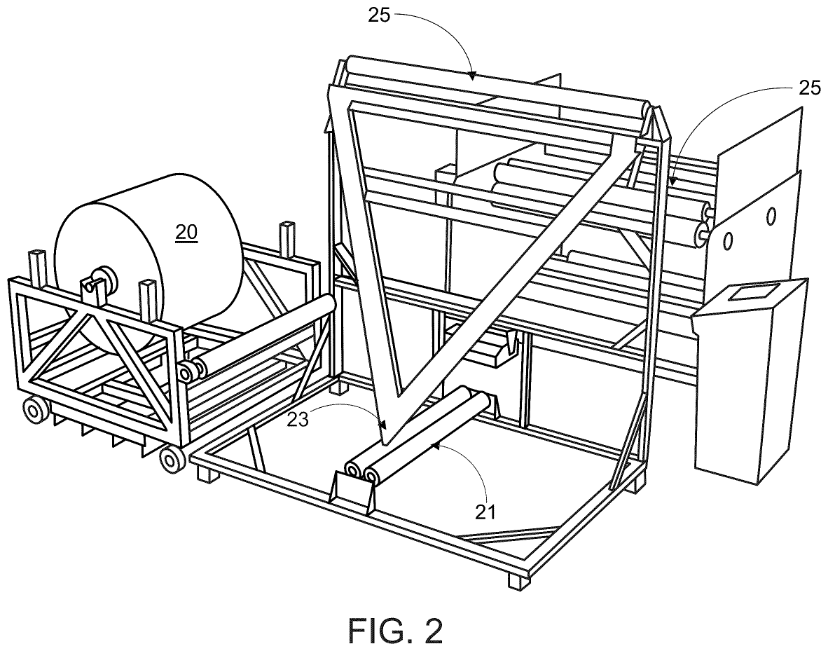

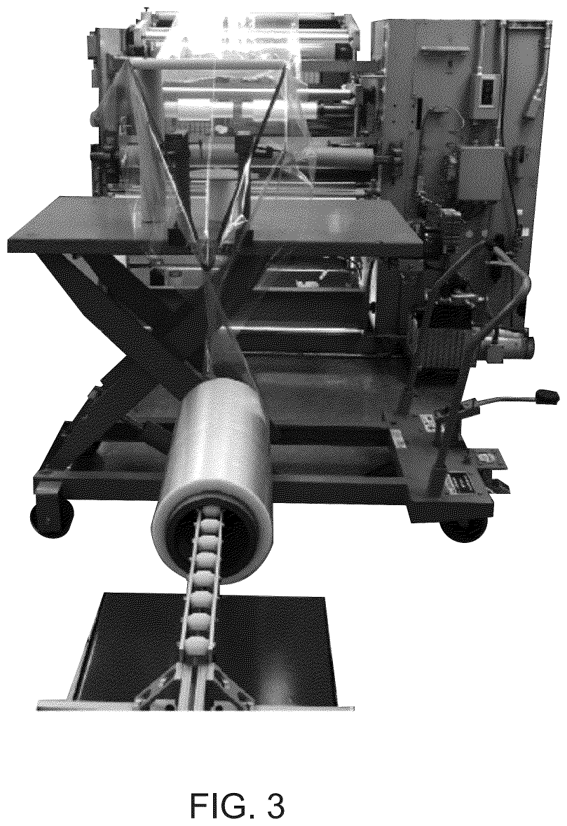

The microporous film, in some embodiments, can be expanded by passing the film over a film expansion apparatus. For example, the microporous film in the folded state is passed over a shearing point to unfold the film. The unfolded film is subsequently sealed along the crease and wound or otherwise collected onto one or more rolls. FIG. 2 is a schematic of a film expansion apparatus, according to some embodiments. As illustrated in FIG. 2, the film 20 is provided on a roll (left) in a folded state. The film 20 is fed to rollers 21 and then passes over a shearing point 23 of a V-frame to effectuate unfolding of the film 20. Once unfolded, the film 20 can pass for to downstream rollers 25 for winding onto a roll or other collection mechanism. In some embodiments, the downstream rollers can assist in flattening or smoothing the unfolded film. Wrinkles and/or other surface imperfections can be eliminated of mitigated by the downstream rollers 25. In some embodiments, microporous film is sealed along the crease immediately after unfolding. Alternatively, the expanded microporous film can be wound after passing over the expansion apparatus and stored for any desired period of time before film sealing along the crease. FIG. 3 illustrates operation of a film expansion apparatus, according to some embodiments.

The porous membrane according to Section I herein can be produced into film form by using a coextrusion facility or laminate facility. As one example, two or more layers of resin compositions having identical components are laminated to prepare a raw film followed by pore opening upon stretching of the two or more layers of the multi-layered membrane to manufacture a porous membrane. As another example, at least one porous membrane containing a polypropylene resin as a main component and at least one porous membrane containing a polyethylene resin as a main component are laminated to prepare a raw film, followed by pore opening upon stretching of the two or more layers of the multi-layered membrane to manufacture a porous membrane. In some cases, it is easier to obtain a porous membrane having higher strength by preparing a raw film in which two or more layer films are first laminated, and then followed by pore opening upon stretching of the film to manufacture a porous membrane, rather than by preparing a raw film using a single layer film followed by the pore opening upon stretching of the film. From this viewpoint, in the case of a multilayered film in which a plurality of polyolefin-based porous layers are laminated, three or more polyolefin-based porous layers are preferably laminated, at least two of a porous layer (PP porous layer) containing a polypropylene resin as a major component and at least one porous layer (PE porous layer) containing a polyethylene resin as a main component are more preferably laminated, and the three-layer membrane of PP porous layer/PE porous layer/PP porous layer laminated in this order, is further preferable.

The porous membrane is preferably manufactured by a dry stretching method in which the film is directly stretched and oriented after melt-kneaded in an extruder without using a solvent, followed by being subjected to an annealing step, cold stretching step, and hot stretching step in this order. A method for extruding a molten resin via a T die followed by orientation upon stretching of the resin, a circular die extrusion method, etc., can be utilized. Particularly the circular die extrusion method is preferable because the membrane can be made into a thin film form. The dry stretching method, in particular, a method of orientating a lamella crystalline followed by pore opening caused by interfacial delamination of the crystals, facilitates to align the pore portion, in contrast to a wet method, and the porous membrane obtained by the method is capable of exhibiting low air permeability resistance with respect to porosity, which is preferable.

Pore opening upon stretching of a film will be described in more detail. A single layer body or multi-layered body of the aforementioned raw films are subjected to stretching treatment. As a stretching condition, uniaxial stretching (MD stretching) can be adopted. A stretching temperature can be adjusted as appropriate according to processing characteristics of a microporous membrane layer (a) of a polypropylene resin or a microporous membrane layer (b) of a polyethylene resin, and further according to an aspect of voids formed in each layer. By such stretching treatment, the voids are provided in each of the microporous membrane layer (a) of polypropylene and polyethylene layer (b). Here, a mechanism (method) of providing the voids includes, for example, a pore opening method at an interface of lamellar crystalline. The pore opening method at a crystalline interface includes a method of preparing a precursor film by melt-extruding, for example, a crystalline resin such as polyethylene, etc., with a high draw down ratio, annealing the precursor film in a temperature range lower by 5 to 50° C. than the crystalline melting point of the crystalline resin to form an annealed precursor film, and subjecting the annealed precursor film to cold uniaxial stretching in temperature range between −20° C. to 70° C. to a factor of 1.1 to 2 followed by uniaxial stretching in a temperature range lower by 5 to 50° C. than the crystalline melting point of the crystalline resin to a factor of 1.5 to 5 to obtain a microporous membrane (i.e., providing voids in the membrane).

The microporous membrane subjected to uniaxial stretching can have an extremely low shrinkage to the TD direction and can be set in the range.

A polyolefin resin composition containing a polyolefin resin can be produced by a melt-kneading method using a single-screw or twinscrew extruder. The obtained resin composition can be used for producing a microporous membrane by a preferable dry method or a less preferred wet method. A dry method includes a method of melt-kneading and extruding a polyolefin resin composition, and then forming a highly oriented film directly from a T die, or a method of forming a highly oriented film by a circular die extrusion method to prepare a raw film, annealing the raw film, micropore opening by cold stretching, and delaminating the polyolefin lamellar crystal interface by hot stretching. According to the circular die extrusion method, for example, a melt-kneaded product of a polypropylene resin composition is blown up from a circular die to MD, and is taken up via a guide plate and a nip roll to obtain a highly crystallized and MD orientated raw film. A wet method includes a method of melt-kneading a polyolefin resin composition and a pore-forming material to prepare in sheet form followed by stretching if necessary, and extracting the pore-forming material from the sheet, a method of dissolving a polyolefin resin composition followed by immersing it in a poor solvent with respect to polyolefin to solidify polyolefin while removing the solvent at the same time, etc.

The polyolefin resin composition can contain a second polymer and/or a resin other than polyolefin, such as an additive, etc. Examples of additives include fluorine-based flow modifying materials, waxes, crystal nucleating materials, antioxidants, metal soaps such as aliphatic carboxylic acid metal salts, ultraviolet absorbers, light stabilizers, antistatic agents, anti-fogging agents, coloring pigments, etc., as described in Section I herein. Melt-kneading of the polyolefin resin composition can be carried out by, for example, a kneader, a laboplast mill, a kneading roll, a Banbury mixer, etc., in addition to a single-screw or twin-screw extruder. Further, a direct compound method of directly molding a film after melt kneading the resin composition in an extruder can also be utilized. Examples of usable plasticizers include hydrocarbons such as liquid paraffin and paraffin wax; esters such as dioctyl phthalate and dibutyl phthalate; and higher alcohols such as oleyl alcohol and stearyl alcohol.

The pore opening step can be carried out by a known dry method or wet method. A stretching step can also be carried out, either during the pore-forming step or before or after the pore-forming step. Stretching treatment can be carried out by uniaxial stretching or biaxial stretching, however, it is preferable to carry out at least MD stretching. When the membrane is being stretched in one direction, the other direction is in a non-constrained state or in an anchored state with fixed length.

In order to suppress shrinkage of the microporous membrane, heat treatment can be carried out to produce heat setting, either after stretching or after pore formation. The heat treatment can include a stretching operation carried out with the prescribed temperature environment and the prescribed degree of stretching to adjust the physical properties, and/or relaxation operation carried out with the prescribed temperature environment and the prescribed degree of relaxation to reduce the stretching stress. The relaxation operation can also be carried out after the stretching operation. The heat treatment can be carried out using a tenter or roll stretcher. A method of producing a microporous membrane by a dry lamellar pore opening method will be described as an example. In the dry lamellar pore opening method, a nonporous precursor in which numerous lamellar structures are bonded via tie molecules, is stretched to cleave the lamellar interface and thereby form pores, without using a solvent such as water or an organic solvent.

A dry lamellar pore opening method can involve (i) a step of extruding a nonporous precursor (highly oriented raw film) formed from a resin composition containing a polyolefin, and (ii) a step of uniaxial stretching the extruded nonporous precursor. The microporous film obtained by the dry lamellar pore-forming method and including steps (i) and (ii) can also be functionalized after the coating, dipping or impregnation step, etc.

Step (i) can be carried out by a conventional extrusion method (single screw, twin screw extrusion method). The extruder can be provided with aT-die or a circular die with elongated holes. The uniaxial stretching in step (ii) can be carried out in the manner described above. The longitudinal direction (MD) stretching can include both cold stretching and hot stretching. From the viewpoint of suppressing the internal distortion of the nonporous precursor, the nonporous precursor can be annealed during step (i), after step (ii), or prior to the stretching in step (ii). The annealing can be carried out in a range, for example, between a temperature lower by 50° C. than the melting point of the polypropylene resin (A) and a temperature lower by 10° C. than the melting point of the polypropylene resin (A), or in a range between a temperature lower by 50° C. than the melting point of the polypropylene resin (A) and a temperature lower by 15° C. than the melting point of polypropylene resin (A).

In accordance with at least certain embodiments, aspects or objects, the present invention or disclosure may address or solve the need, issue or problem of past membranes being too narrow for the textile industry, by providing an at least 50 inch wide, preferably at least 60 inch wide polyolefin membrane having a thickness of less than 100 um or microns, preferably less than 50 um.

In accordance with at least certain embodiments, aspects or objects, the present invention or disclosure provides a wide microporous dry process membrane comprising:
one or more layers comprising a folded dry stretch polyolefin membrane having a folded side and an open side; and,
which when unfolded has a width of at least 40 inches and is adapted for use as at least one layer in a textile, garment, clothing, PPE, tent, awning, separator, diaper, cover, filter, automotive fabric, seat fabric, shoes, or the like.

The wide microporous dry process membrane above, which when unfolded has a width of at least 60 inches.

The wide microporous dry process membrane above, which is adapted for use in Level 3 PPE.

The wide microporous dry process membrane above, which is adapted for use in Level 4 PPE.

The wide microporous dry process membrane above, which is adapted for use in automotive seat fabric.

### Example

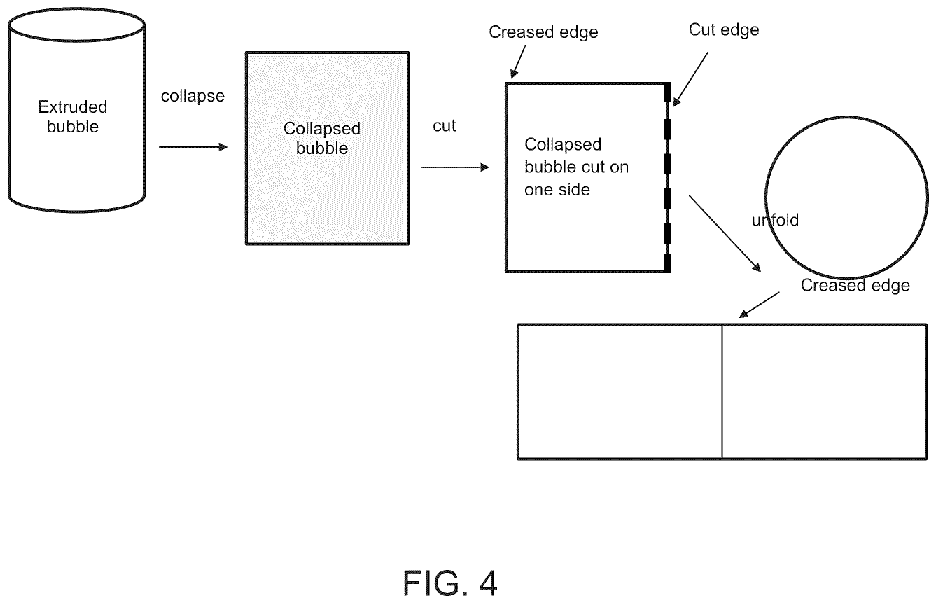

In one embodiment, a film is formed using a blown film (bubble/cylinder) extrusion process. After the bubble is collapsed, one side edge of the film is cut (opposite a creased edge that needs to be sealed), and the collapsed and cut film is unfolded. A schematic version of this process is shown in FIG. 4. The resulting film has a width twice that of the collapsed bubble.

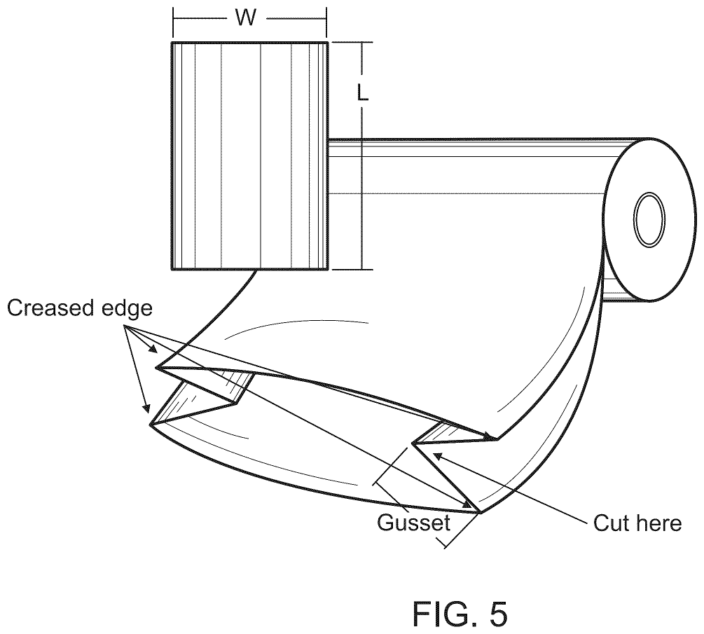

In other Examples the blown film may be non-cylindrical, e.g., gusseted or accordion. FIG. 5 shows where a gusseted collapsed film may be cut before unfolding. The unfolded film will have multiple creased edges that need to be sealed.

In one embodiment, the invention provides a wide microporous film comprising: one or more layers comprising a polyolefin; wherein the microporous film has a width of at least 50 inches and comprises one or more non-porous regions.

In another embodiment, the invention provides the microporous film of any embodiment described herein and wherein the width is at least 60 inches.

In another embodiment, the invention provides the microporous film of any embodiment described herein and wherein the non-porous region is located along a central region of the microporous film.

In another embodiment, the invention provides the microporous film of any embodiment described herein and wherein the non-porous region traverses the microporous film surface along the central region.

In another embodiment, the invention provides the microporous film of any embodiment described herein and wherein the one or more non-porous regions exhibit a re-solidified polymeric structure.

In another embodiment, the invention provides the microporous film of any embodiment described herein and wherein the one or more non-porous regions are located along a crease in the microporous film.

In another embodiment, the invention provides the microporous film of any embodiment described herein and wherein the polyolefin comprises a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

In another embodiment, the invention provides the microporous film of any embodiment described herein and wherein the polyolefin is polyethylene, polypropylene, or a combination of both.

In another embodiment, the invention provides the microporous film of any embodiment described herein and, wherein the film is a single layer film.

In another embodiment, the invention provides the microporous film of any embodiment described herein and wherein the film is a trilayer film.

In another embodiment, the invention provides the microporous film of any embodiment described herein and wherein the film is a multilayer film.

In another embodiment, the invention provides the microporous film of any embodiment described herein and wherein the layers are laminated together.

In another embodiment, the invention provides a wide microporous film of any embodiment described herein and wherein the microporous membrane comprises a thickness of about 1 microns to about 50 microns, about 5 microns to about 40 microns, about 5 microns to about 30 microns, about 5 microns to about 20 microns, or about 5 to 10 microns.

In another embodiment, the invention provides the wide microporous film of any embodiment described herein and wherein the film has a thickness standard deviation of no more than 2.0 micron, no more than 1.0 microns, or no more than 0.5 microns.

In another embodiment, the invention provides the wide microporous film of any embodiment described herein and wherein the film has a Gurley value of 1 to 1,000 s/100 cc.

In another embodiment, the invention provides the wide microporous film of any embodiment described herein and wherein the film comprises a porosity of 20% to 80%.

In another embodiment, the invention provides the wide microporous film of any embodiment described herein and wherein the film has a puncture strength of 300-1500 gf.

In another embodiment, the invention provides the wide microporous film of any embodiment described herein and wherein the film is a textile or garment fabric.

In another embodiment, the invention provides a method of forming a wide microporous film comprising: providing a microporous film; and expanding width of the microporous film around a crease in the microporous film; and sealing the microporous film along the crease to provide one or more non-porous regions.

In another embodiment, the invention provides the method of forming a wide microporous film according to any embodiment herein and wherein the width of the expanded microporous film is at least 60 inches.

In another embodiment, the invention provides the method of forming a wide microporous film according to any embodiment herein and wherein sealing comprises melting and re-solidifying the microporous film along the crease.

In another embodiment, the invention provides the method of forming a wide microporous film according to any embodiment herein and, wherein expanding the microporous film comprises unfolding the microporous film along the crease.

In another embodiment, the invention provides the method of forming a wide microporous film according to any embodiment herein and wherein the microporous film is melted with a heated roller passing along the crease.

In another embodiment, the invention provides the method of forming a wide microporous film according to any embodiment herein and wherein the microporous film is formed of polyolefin.

In another embodiment, the invention provides the method of forming a wide microporous film according to any embodiment herein and wherein the polyolefin comprises a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

In another embodiment, the invention provides the method of forming a wide microporous film according to any embodiment herein and wherein the polyolefin is polyethylene, polypropylene, or a combination of both.

In another embodiment, the invention provides the method of forming a wide microporous film according to any embodiment herein and wherein the microporous film is a single layer film or a multilayer film.

In another embodiment, the invention provides the method of forming a wide microporous film according to any embodiment herein and wherein the crease extends in a machine direction of the microporous film.

In yet another embodiment, the invention provides a wide microporous dry process membrane comprising: one or more layers comprising a folded dry stretch polyolefin membrane having a folded side and an open side; and, which when unfolded has a width of at least 40 inches and is adapted for use as at least one layer in a textile, garment, clothing, PPE, tent, awning, separator, diaper, cover, filter, automotive fabric, seat fabric, shoes, or the like.

In another embodiment, the invention provides a wide microporous dry process membrane according to any embodiment disclosed herein and which when unfolded has a width of at least 60 inches.

In another embodiment, the invention provides a wide microporous dry process membrane according to any embodiment disclosed herein and is adapted for use in Level 3 PPE.

In another embodiment, the invention provides a wide microporous dry process membrane according to any embodiment disclosed herein and which is adapted for use in Level 4 PPE.

In another embodiment, the invention provides a wide microporous dry process membrane according to any embodiment disclosed herein and which is adapted for use in automotive seat fabric.

In another embodiment, the invention provides a wide microporous dry process membrane according to any embodiment disclosed herein and wherein providing a film comprises a blown extrusion process wherein the shape of the blown film is at least one of cylindrical, gusseted, or accordion-shaped.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1-34. (canceled)

35. A wide microporous film comprising:
one or more layers comprising a polyolefin;
wherein the microporous film has a width of at least 127 cm and comprises one or more non-porous regions.

36. The microporous film of claim 35, wherein the width is at least 152.4 cm.

37. The microporous film of claim 35, wherein the non-porous region is located along a central region of the microporous film.

38. The microporous film of claim 37, wherein the non-porous region traverses the microporous film surface along the central region.

39. The microporous film of claim 35, wherein the one or more non-porous regions exhibit a re-solidified polymeric structure.

40. The microporous film of claim 35, wherein the one or more non-porous regions are located along a crease in the microporous film.

41. The wide microporous film of claim 35, wherein the polyolefin comprises a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

42. The wide microporous film of claim 35, wherein the polyolefin is polyethylene, polypropylene, or a combination of both.

43. The wide microporous film of claim 35, wherein the film is a single layer film.

44. The wide microporous film of claim 35, wherein the film is a trilayer film.

45. The wide microporous film of claim 35, wherein the film is a multilayer film.

46. The wide microporous film of claim 45, wherein the layers are laminated together.

47. The wide microporous film of claim 35, wherein the microporous membrane comprises a thickness of about 1 microns to about 50 microns, about 5 microns to about 40 microns, about 5 microns to about 30 microns, about 5 microns to about 20 microns, or about 5 to 10 microns.

48. The wide microporous film of claim 44, wherein the film has a thickness standard deviation of no more than 2.0 micron, no more than 1.0 microns, or no more than 0.5 microns.

49. The wide microporous film of claim 35, wherein the film has a Gurley value of 1 to 1,000 s/100 cc.

50. The wide microporous film of claim 35, wherein the film comprises a porosity of 20% to 80%.

51. The wide microporous film of claim 35, wherein the film has a puncture strength of 300-1500 gf.

52. The wide microporous film of claim 35, wherein the film is a textile or garment fabric.

53. A method of forming a wide microporous film comprising:
providing a microporous film; and
expanding width of the microporous film around a crease in the microporous film; and
sealing the microporous film along the crease to provide one or more non-porous regions.

54. The method of claim 53, wherein the width of the expanded microporous film is at least 152.4 cm.

55. The method of claim 53, wherein sealing comprises melting and re-solidifying the microporous film along the crease.

56. The method of claim 53, wherein expanding the microporous film comprises unfolding the microporous film along the crease.

57. The method of claim 55, wherein the microporous film is melted with a heated roller passing along the crease.

58. The method as in claim 53, wherein the microporous film is formed of polyolefin.

59. The method of claim 24, wherein the polyolefin comprises a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

60. The method of claim 58, wherein the polyolefin is polyethylene, polypropylene, or a combination of both.

61. The method of claim 58, wherein the microporous film is a single layer film or a multilayer film.

62. The method of claim 53, wherein the crease extends in a machine direction of the microporous film.

63. A wide microporous dry process membrane comprising:
one or more layers comprising a folded dry stretch polyolefin membrane having a folded side and an open side; and,
which when unfolded has a width of at least 101.6 cm and is adapted for use as at least one layer in a textile, garment, clothing, PPE, tent, awning, separator, diaper, cover, filter, automotive fabric, seat fabric, shoes, or the like.

64. The wide microporous dry process membrane of claim 63, which when unfolded has a width of at least 152.4 cm.

65. The wide microporous dry process membrane of claim 63, which is adapted for use in Level 3 PPE.

66. The wide microporous dry process membrane of claim 63, which is adapted for use in Level 4 PPE.

67. The wide microporous dry process membrane of claim 63, which is adapted for use in automotive seat fabric.

68. The method of claim 53, wherein providing a film comprises a blown extrusion process wherein the shape of the blown film is at least one of cylindrical, gusseted, or accordion-shaped.
